(19) United States
(12) Patent Application Publication
(10) Pub. No.: US 2021/0042555 A1
(43) Pub. Date: Feb. 11, 2021

(54) Information Processing Apparatus and Table Recognition Method

(71) Applicant: Hitachi, Ltd., Tokyo (JP)

(72) Inventors: Ryosuke ODATE, Tokyo (JP); Hiroshi SHINJO, Tokyo (JP)

(21) Appl. No.: 16/819,257

(22) Filed: Mar. 16, 2020

(30) Foreign Application Priority Data
Aug. 9, 2019 (JP) 2019-147653

(51) Int. Cl. G06K 9/46; G06K 9/34; G06K 9/00

(52) U.S. Cl. CPC G06K 9/46; G06K 2209/01; G06K 9/00449; G06K 9/344

(57) ABSTRACT

An information processing apparatus which performs table recognition on an input image including a joined table area including different table areas joined performs character recognition processing on at least the joined table area of the input image, extracts an item name from a character string obtained as a result of the character recognition processing, and recognizes, when detecting, in a column or a row having one item name as a starting point in the joined table area, an item name different from the one item name at a position advanced in one direction, an area that extends from the different item name as a different table area.

### CROSS-REFERENCE TO PRIOR APPLICATION

This application relates to and claim the benefit of priority from Japanese Patent Application No. 2019-147653 filed on Aug. 9, 2019 the entire disclosure of which is incorporated herein by reference.

### BACKGROUND

The present invention relates to an information processing apparatus and a table recognition method.

Since the character recognition technology has been spread, the automation of manual processes has been progressed. For example, inputting contents in a document to a database has been automated by utilizing character recognition processing. In recent years, creating a database of contents in a table has also been automated by utilizing the character recognition processing.

To automatically create a database of contents in a table in a document image, it is necessary to acquire character strings from the table with the use of the character recognition processing, and extract item names in the table and item values corresponding to the item names from the acquired character strings. Note that, item names mean character strings representing information types and are generally written in the uppermost row or leftmost column of a table in many cases. Further, item values mean contents corresponding to item names. The processing of acquiring, from a table, character strings corresponding to the item names and the item values is herein referred to as “table recognition”.

To achieve table recognition, a method that involves checking character strings acquired by character recognition processing against an item name dictionary prepared in advance to identify the coordinates of an item name in a table, to thereby identify the corresponding item value has been considered.

For example, in Japanese Patent Application Laid-open No. 2006-92207, there is disclosed a document attribute acquiring apparatus including a table area estimating unit configured to estimate, from document data, an area including the attribute and attribute content thereof as a table area, a character recognizing unit configured to recognize characters in the table area, an attribute recognizing unit configured to recognize the attribute on the basis of a recognition result by the character recognizing unit, and an extraction unit configured to extract a character string at a position corresponding to the attribute recognized by the attribute recognizing unit, as the attribute content in association with the attribute.

Using the technology described in Japanese Patent Application Laid-open No. 2006-92207 makes it possible to estimate a table area in a document image and recognize characters in the table area to extract item names and item values in the table area, to thereby create a database.

Targets of the processing by the technology described in Japanese Patent Application Laid-open No. 2006-92207 are tables each having two rows and n columns or n rows and two columns, and item names all written in the same row or column. Thus, the technology has a problem in recognizing complicated tables such as tables having a larger number of rows or columns or tables having item names sparsely distributed in the tables. Note that, a table area having item names sparsely distributed in tables is regarded as a joined table area obtained by joining table areas having a plurality of tables semantically different from each other.

The present invention has been made in view of the above-mentioned problem, and provides an information processing apparatus and a table recognition method that can semantically decompose a plurality of different tables joined, to thereby recognize the tables.

### SUMMARY

In order to solve the above-mentioned problem, according to one aspect of the present invention, there is provided an information processing apparatus which performs table recognition on an input image including a joined table area including different table areas joined, the information processing apparatus configured to: perform character recognition processing on at least the joined table area of the input image; extract an item name from a character string obtained as a result of the character recognition processing; and recognize, when detecting, in a column or a row having one item name as a starting point in the joined table area, an item name different from the one item name at a position advanced in one direction, an area that extends from the different item name as a different table area.

According to the present invention, it is possible to achieve an information processing apparatus and a table recognition method that can semantically decompose a plurality of different tables joined, to thereby recognize the tables.

### BRIEF DESCRIPTION OF THE DRAWINGS

FIG. 1 is a diagram illustrating the schematic configuration of an information processing apparatus according to an embodiment.

FIG. 2 is a flowchart illustrating an example of operation of the information processing apparatus according to the embodiment.

FIG. 3 is a diagram illustrating an example of layout data according to the embodiment.

FIG. 4 is a diagram illustrating an example of character recognition result data according to the embodiment.

FIG. 5 is a diagram illustrating an example of a complex table image that is an input image.

FIG. 6 is a schematic diagram illustrating the result of table recognition processing by the information processing apparatus according to the embodiment.

FIG. 7 is a flowchart illustrating an example of table separation and item name-item value association processing by the information processing apparatus according to the embodiment.

FIG. 8 is a flowchart illustrating an example of item name detection processing by the information processing apparatus according to the embodiment.

FIG. 9 is a diagram illustrating an example of item dictionary data according to the embodiment.

FIG. 10 is a flowchart illustrating an example of item name-item value correspondence detection processing by the information processing apparatus according to the embodiment.

FIG. 11 is a flowchart illustrating an example of table recognition result correction processing by the information processing apparatus according to the embodiment.

FIG. 12 is a diagram illustrating an example of a screen that is displayed on an output apparatus of the information processing apparatus according to the embodiment.

### DETAILED DESCRIPTION OF THE EMBODIMENT

Now, an embodiment of the present invention is described with reference to the drawings. Note that, the embodiment described below is not intended to limit the invention according to the scope of claims. Further, not all various elements and combinations thereof described in the embodiment are essential to the solving means of the present invention.

An information processing apparatus and a table recognition method according to the present embodiment have the following configurations as examples.

The present embodiment has an object to semantically decompose a plurality of different tables joined, to thereby recognize each table after decomposition. To achieve the object, in the embodiment, an attention is paid to item names in a table area, and the semantic boundaries between a plurality of tables joined are detected. In general, item names are written in the uppermost row or leftmost column of a table in many cases. However, in a table area including a plurality of tables joined, item names are often written in the inner portions of the tables. Accordingly, item names detected in the inner portions of the tables are regarded as table semantic changes and the tables are separated from each other to be recognized. Further, in the embodiment, a GUI (Graphical User Interface) for recognition result confirmation and the enhancement of an item name dictionary that is used in item name detection is presented.

Note that, in the drawings illustrating the embodiment, the parts having the same functions are denoted by the same reference symbols, and the repetitive description thereof is omitted.

Further, in the following description, an expression such as “xxx data” is sometimes used as an example of information, but the information has any data structure. Specifically, to indicate that the information does not depend on data structures, “xxx data” can be called “xxx table”. Further, in the following description, the configuration of each piece of information is an example, and the information may be divided to be held or the pieces of information may be combined to be held.

### Embodiment 1

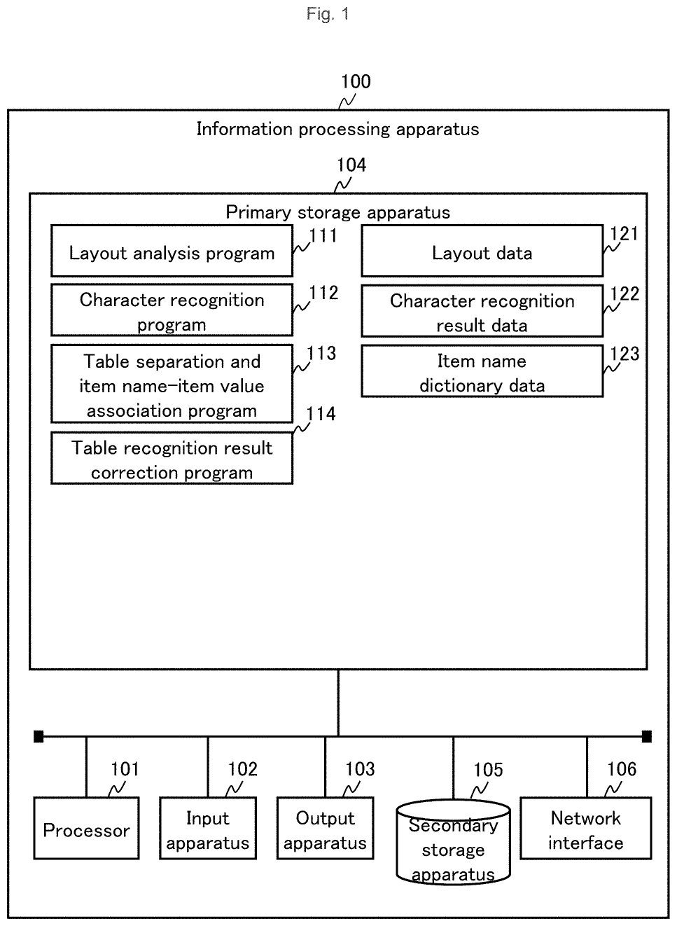

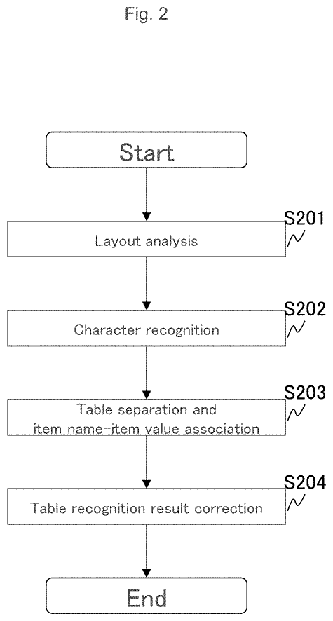

First, with reference to FIG. 1, the hardware configuration and software configuration of an information processing apparatus of Embodiment 1 is described. With reference to FIG. 2 and the subsequent figures, the processing of the table recognition method that the information processing apparatus executes is described.

FIG. 1 is a diagram illustrating the schematic configuration of the information processing apparatus according to the embodiment.

An information processing apparatus 100 is an apparatus capable of performing various kinds of information processing, and is an information processing apparatus such as a computer, for example. The information processing apparatus 100 executes processing related to the separation of table areas joined in an image and the recognition of the tables. Further, the information processing apparatus 100 also executes processing related to a GUI for the confirmation and correction of table recognition results.

The information processing apparatus 100 includes a processor 101, an input apparatus 102, an output apparatus 103, a primary storage apparatus 104, a secondary storage apparatus 105, and a network interface 106. The hardware components are coupled to each other through an internal bus or the like. The number of each hardware component, which is one in FIG. 1, may be two or more. Types of networks for coupling are not limited. Via a network or through direct coupling, data may be transmitted to or received from another computer or storage apparatus, or the processing may be shared with another calculator or storage apparatus.

The processor 101 includes, for example, an arithmetic element such as a CPU (Central Processing Unit) or a FPGA (Field-Programmable Gate Array), and executes programs that are stored in the primary storage apparatus 104. The processor 101 executes processing in accordance with a program, to thereby achieve a specific function. In the following description, a description on processing that uses a program as a subject indicates that the processor 101 executes the program.

The input apparatus 102 is an apparatus for inputting data to the information processing apparatus 100. For example, the input apparatus 102 includes a device for computer operation, such as a keyboard, a mouse, or a touch panel. Further, the input apparatus 102 also includes a device for acquiring images, such as a scanner, a digital camera, or a smartphone.

The output apparatus 103 is an apparatus configured to output data input screens, data processing results, and the like. The output apparatus 103 includes a touch panel, a display, or the like.

The primary storage apparatus 104 stores programs that the processor 101 executes and information that the programs use. Further, the primary storage apparatus 104 includes a work area that the programs temporarily use. As the primary storage apparatus 104, for example, a memory is conceivable.

The primary storage apparatus 104 of the present embodiment stores a layout analysis program 111, a character recognition program 112, a table separation and item name-item value association program 113, and a table recognition result correction program 114. The program 111, the program 112, the program 113, and the program 114 correspond to processing in Step S201, processing in S202, processing in S203, and processing in S204 in FIG. 2, respectively.

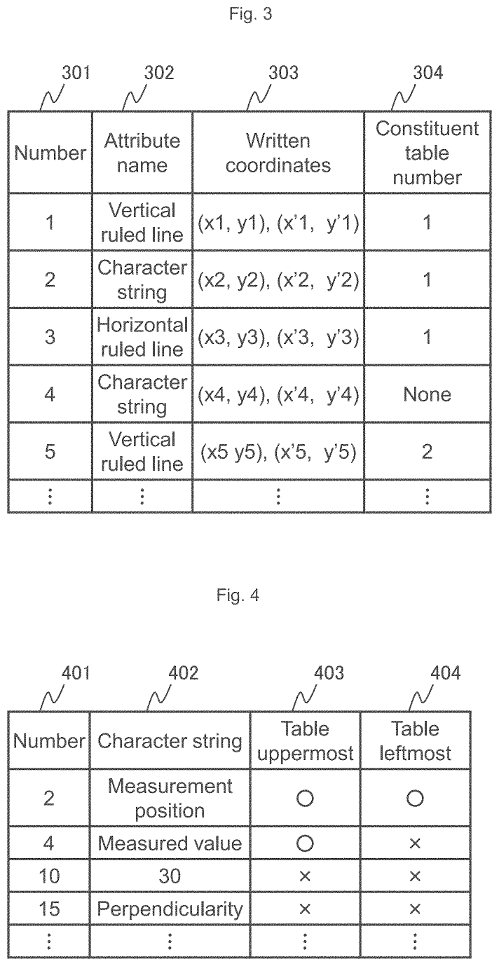

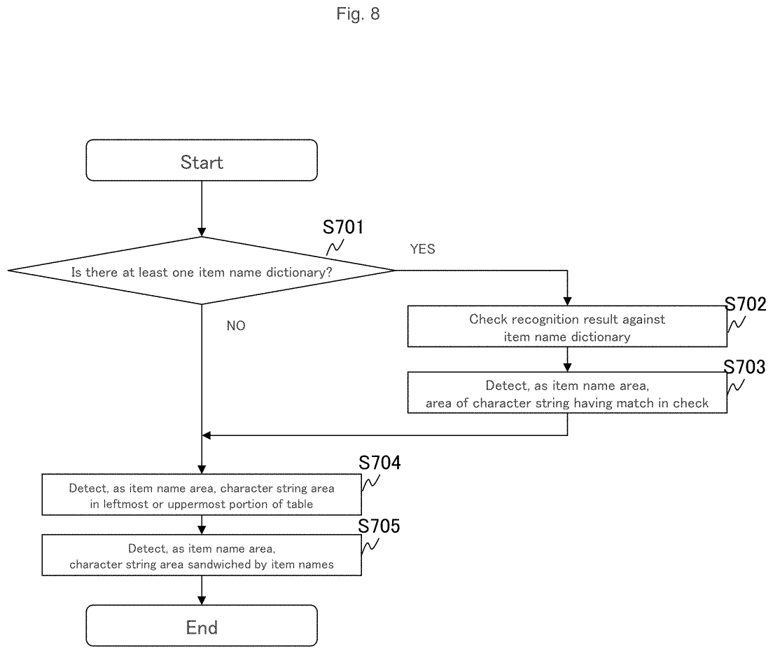

Further, the primary storage apparatus 104 stores layout data 121, character recognition result data 122, and item name dictionary data 123. The layout data 121, the character recognition result data 122, and the item name dictionary data 123 are described in detail in FIG. 3, FIG. 4, and FIG. 8, respectively. The details of the processing of each module that the primary storage apparatus 104 executes, and information that is stored in the primary storage apparatus are described with reference to FIG. 2 and the subsequent figures.

It is sufficient for the primary storage apparatus 104 to achieve some necessary modules, and the primary storage apparatus 104 does not necessarily store programs and information for achieving all the modules.

The secondary storage apparatus 105 permanently stores data. As the secondary storage apparatus 105, for example, an HDD (Hard Disk Drive) or an SSD (Solid State Drive) is conceivable. Note that, the programs and information that are stored in the primary storage apparatus 104 may be stored in the secondary storage apparatus 105. In this case, the processor 101 reads the programs and information from the secondary storage apparatus 105 to load the programs and information to the primary storage apparatus 104.

FIG. 2 is a flowchart illustrating an example of operation of the information processing apparatus 100 according to the embodiment, and is a flowchart illustrating the overview of table recognition processing by the information processing apparatus 100.

First, the layout analysis program 111 of the information processing apparatus 100 performs layout analysis processing on an input image. The layout analysis processing is processing that is generally performed as the preprocessing of character recognition, and can be achieved with the use of known methods. For example, the following is conceivable: an input image is converted to a black and white binary image, and connected black pixel components are extracted so that ruled lines, character strings, a table area, and the like are extracted from the image.

The layout analysis program 111 acquires the layout data 121 as the result of the processing in Step S201. The layout data 121 is described later with reference to FIG. 3. Note that, the input image in Step S201 may be, other than an image acquired from the input apparatus 102, an image stored in the secondary storage apparatus 105 or in an external storage apparatus, or an image acquired through the network interface 106.

Input images in the information processing apparatus 100 and the table recognition method of the embodiment are each an image of a printed document (including a table area) obtained with the use of a device for acquiring images, such as a scanner, a digital camera, or a smartphone. The input images may be in any format, and images in known formats such as bitmap images or JPEG (Joint Photographic Experts Group) images are applicable thereto. In addition, with regard to PDF (Portable Document Format) documents, although item names and item values can be easily extracted as text, information on tables is stored as images, for example. Thus, the input images used herein can include PDF documents.

Next, the character recognition program 112 of the information processing apparatus 100 performs character recognition processing (Step S202). The character recognition processing is the processing of distinguishing the character classes of the character strings extracted in Step S201, and can be achieved with the use of known methods. For example, the following is conceivable: a directional feature is extracted from a character string image, and the character class is distinguished by nearest neighbor search of a character recognition dictionary with the use of the directional feature.

The character recognition program 112 acquires the character recognition result data 122 as the result of the processing in Step S202. The character recognition result data 122 is described later with reference to FIG. 4.

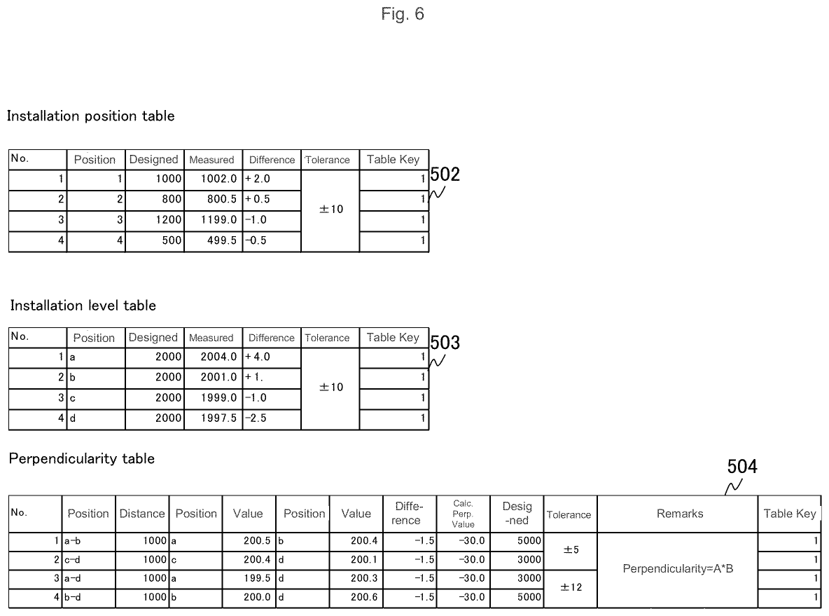

Moreover, the table separation and item name-item value association program 113 of the information processing apparatus 100 performs table separation and item name-item value association processing (Step S203). The table separation and item name-item value association processing detects the semantic boundaries of a plurality of tables joined to semantically separate the tables, and associates item names and item values in each table after separation with each other, to thereby acquire a table recognition result. The details of the processing in Step S203 are described later with reference to FIG. 6.

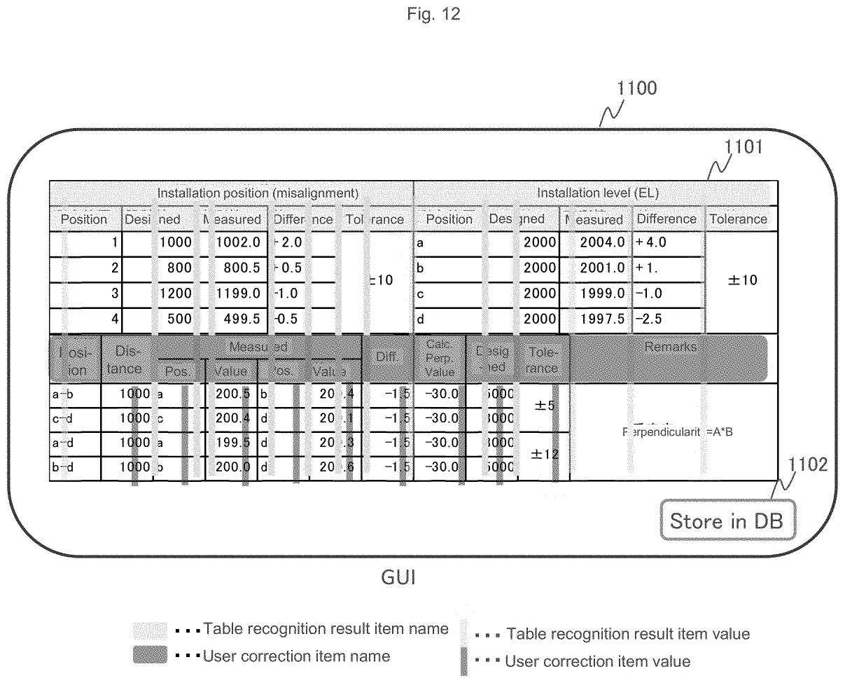

Then, the table recognition result correction program 114 of the information processing apparatus 100 presents the table recognition result acquired in Step S203 on a GUI, and receives confirmation and correction information (Step S204). The details of the processing in Step S204 are described later with reference to FIG. 11. Further, the details of the GUI are described later with reference to FIG. 12.

FIG. 3 is a diagram illustrating an example of the layout data 121 according to the embodiment.

The layout data 121 has, as entries, objects extracted in the layout analysis processing in Step S201. The layout data 121 includes an object number 301, an attribute name 302, a written coordinates 303, and a constituent table number 304.

The object number 301 stores numbers for uniquely identifying each object extracted in the layout analysis processing in Step S201.

The attribute name 302 stores information indicating the attributes of the entries. An attribute, for example, a vertical ruled line, a horizontal ruled line, or a character string is given to each entry.

The written coordinates 303 stores the coordinates of the start point and end point of each entry in an image.

The constituent table number 304 stores numbers for uniquely identifying tables including the entries as constituent elements.

FIG. 4 is a diagram illustrating an example of the character recognition result data 122 according to the embodiment.

The character recognition result data 122 has, as entries, character class distinction results acquired in the character recognition processing in Step S202 to be classified depending on character strings. The character recognition result data 122 includes an object number 401, a character string 402, a table uppermost flag 403, and a table leftmost flag 404.

The object number 401 stores numbers for uniquely identifying each object and corresponds to the object number 301 in FIG. 3.

The character string 402 stores character strings acquired in the character recognition processing.

The table uppermost flag 403 is a flag indicating whether or not an entry corresponds to characters written in the uppermost row of a table.

The table leftmost flag 404 is a flag indicating whether or not an entry corresponds to characters written in the leftmost column of the table.

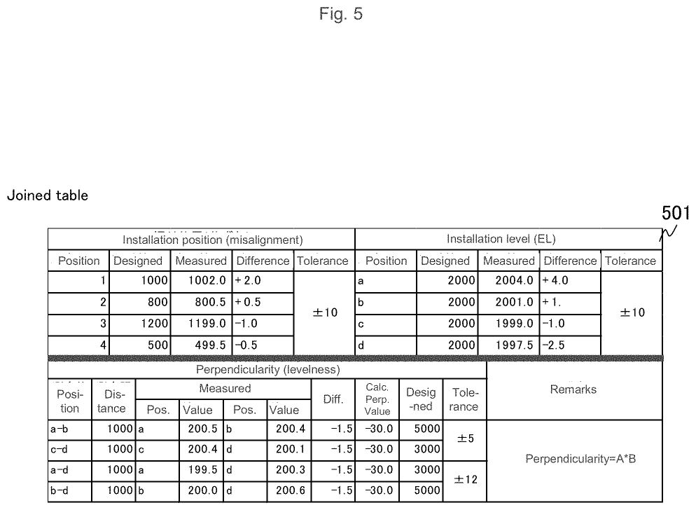

FIG. 5 is a diagram illustrating an example of a complex table image that is an input image. FIG. 6 is a schematic diagram illustrating the result of the table recognition processing by the information processing apparatus 100 according to the embodiment.

A complex table 501 illustrated in FIG. 5 is an example of a table in which the dimensions and the like of a certain design drawing are written. In one table area, the three different tables of an installation position table, an installation level table, and a perpendicularity (levelness) table are included. At this time, the information processing apparatus 100 of the embodiment acquires, as a table recognition processing result, a database including the three separate tables of an installation position table 502, an installation level table 503, and a perpendicularity table 504, as illustrated in FIG. 6. Note that, the tables each have a joined table key as a link between the tables originally joined to each other, and can be cross-referenced.

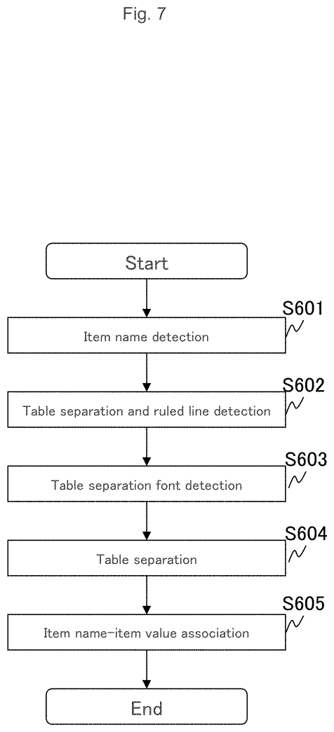

FIG. 7 is a flowchart illustrating an example of the table separation and item name-item value association processing by the information processing apparatus 100 according to the embodiment.

First, the table separation and item name-item value association program 113 of the information processing apparatus 100 checks the character recognition result data 122 against the item name dictionary data 123, to thereby detect item names (Step S601). The details of the item name detection processing are described later with reference to FIG. 8.

Next, the table separation and item name-item value association program 113 of the information processing apparatus 100 performs table separation and ruled line detection processing (Step S602). The table separation and ruled line detection processing detects ruled lines that are considered to semantically separate tables from each other. For example, the following processing is considerable: the thickness of a ruled line is calculated on the basis of the written coordinates 303 of the layout data 121 in FIG. 3, and when the thickness is equal to or larger than a threshold, the ruled line is determined as a table separation ruled line. Further, table separation ruled lines can be detected from color changes.

Next, the table separation and item name-item value association program 113 of the information processing apparatus 100 performs table separation font detection processing (Step S603). The table separation font detection processing detects fonts that are considered to semantically separate tables from each other. For example, the detection of a change in thickness, color, or character class of a character string is conceivable.

Moreover, the table separation and item name-item value association program 113 of the information processing apparatus 100 performs table separation processing on the basis of the processing results in Step S601 to S603 (Step S604).

Specifically, the table separation and item name-item value association program 113 of the information processing apparatus 100 regards tables present across the position of an item name, a table separation ruled line, or a table separation font as having different meanings, thereby separating the joined table. In a case where the separation is based on the item name or the table separation font, an area on the left and upper sides of the character string is defined as Table 1, whereas an area on the lower and right sides of the character string is defined as Table 2. In a case where the separation is based on the table separation ruled line, an area on the upper or left side of the table separation ruled line is defined as Table 1, whereas an area on the lower or right side thereof is defined as Table 2.

Note that, the processing branches based on the up, down, left, and right directions in the present processing assume general tables. Depending on application targets, the branches may be switched or the directions of determination may be changed. Further, such changes may be made in another processing described later.

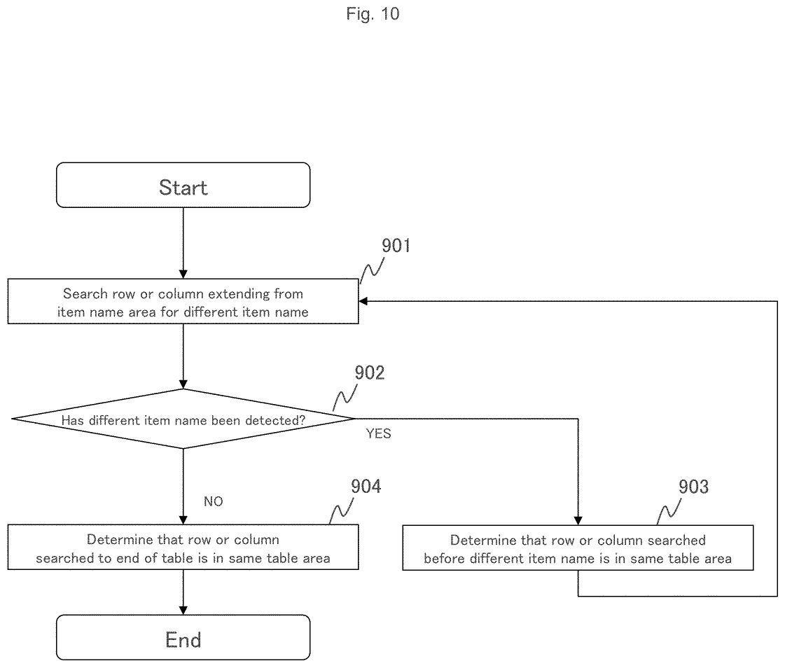

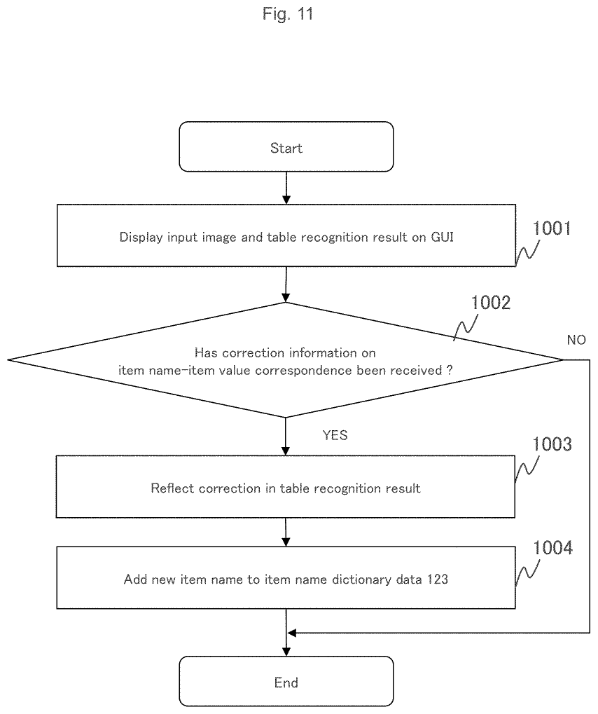

Then, the table separation and item name-item value association program 113 of the information processing apparatus 100 performs the item name-item value association processing (Step S605). The item name-item value association processing associates the item names with item values in each of the tables separated from each other from Step S601 to Step S604. The details of the processing are described later with reference to FIG. 10.

FIG. 8 is a flowchart illustrating an example of the item name detection processing by the information processing apparatus 100 according to the embodiment, and is a flowchart illustrating the item name detection processing corresponding to Step S601 in FIG. 7.

First, the table separation and item name-item value association program 113 of the information processing apparatus 100 branches the processing depending on whether there is the item name dictionary data 123 or not (Step S701). In a case where there is the item name dictionary data 123, the table separation and item name-item value association program 113 of the information processing apparatus 100 proceeds to Step S702. In a case where there is no item name dictionary data 123, the table separation and item name-item value association program 113 of the information processing apparatus 100 proceeds to Step S703. Note that, the item name dictionary data is data that defines character strings serving as item names, and is described later with reference to FIG. 8.

Next, the table separation and item name-item value association program 113 of the information processing apparatus 100 checks the character recognition result data 122 against the item name dictionary data 123 (Step S702).

Next, the table separation and item name-item value association program 113 of the information processing apparatus 100 detects, as an item name area, the area of each character string having a match in the check (Step S703).

Next, the table separation and item name-item value association program 113 of the information processing apparatus 100 detects, as an item name area, a character string area in the leftmost or uppermost portion of the table (Step S704).

Then, the table separation and item name-item value association program 113 of the information processing apparatus 100 detects, as an item name area, a character string area sandwiched by item names (Step S705).

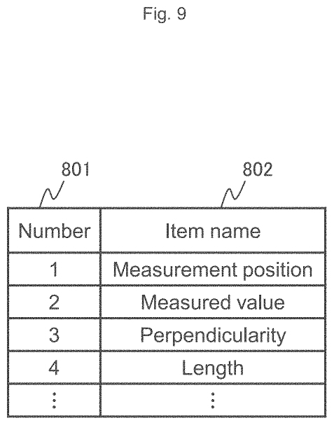

FIG. 9 is a diagram illustrating an example of the item name dictionary data 123 according to the embodiment.

The item name dictionary data 123 has item name character strings as entries. The item name dictionary data 123 includes a dictionary number 801 and an item name 802.

FIG. 10 is a flowchart illustrating an example of the item name-item value correspondence detection processing by the information processing apparatus 100 according to the embodiment, and is a flowchart illustrating the item name-item value correspondence detection processing corresponding to Step S605 in FIG. 7. The item name-item value correspondence detection processing is performed for each row or column.

First, the table separation and item name-item value association program 113 of the information processing apparatus 100 searches character strings in rows extending right or columns extending down from the item name area, which has been detected in the item name detection processing in FIG. 8, for different item names (Step S901).

Next, the table separation and item name-item value association program 113 of the information processing apparatus 100 branches the processing depending on whether a different item name has been detected or not (Step S902). In a case where there is a different item name, the table separation and item name-item value association program 113 of the information processing apparatus 100 proceeds to Step S903. In a case where there is no different item name, the table separation and item name-item value association program 113 of the information processing apparatus 100 proceeds to Step S904.

Next, the table separation and item name-item value association program 113 of the information processing apparatus 100 determines that rows or columns searched before the different item name has been detected are in the same table area as the item name that is the search starting point, and recursively proceeds to Step S901 (Step S903).

Then, the table separation and item name-item value association program 113 of the information processing apparatus 100 determines that rows or columns searched to the end of the table are in the same table area as the item name that is the search starting point (Step S904).

FIG. 11 is a flowchart illustrating an example of the table recognition result correction processing by the information processing apparatus 100 according to the embodiment.

First, the table recognition result correction program 114 of the information processing apparatus 100 displays an input image and a table recognition result on the output apparatus 103 (Step S1001). A GUI displayed on the output apparatus 103 is described later with reference to FIG. 12.

Next, the table recognition result correction program 114 of the information processing apparatus 100 receives correction information on an item name-item value correspondence input on the GUI through the input apparatus 102 (Step S1002). When receiving the correction information, the table recognition result correction program 114 of the information processing apparatus 100 proceeds to Step S1003. When not receiving the correction information, the table recognition result correction program 114 of the information processing apparatus 100 ends the processing.

Next, the table recognition result correction program 114 of the information processing apparatus 100 reflects the received correction in the table recognition result (Step S1003).

Then, next, the table recognition result correction program 114 of the information processing apparatus 100 adds character strings newly designated as item names by correction to the item name dictionary data 123 (Step S1004). Note that, the character strings may not be immediately added, and the processing of holding the adding processing for a certain period or the processing of presenting the character strings to a person to allow the person to determine whether to add the character strings to the dictionary may be added.

FIG. 12 is a diagram illustrating an example of a screen 1100 that is displayed on the output apparatus 103 of the information processing apparatus 100 according to the embodiment, and is a diagram illustrating an example of a GUI for the confirmation and correction of a table recognition result. The GUI is used in the table recognition result correction processing in FIG. 11.

1101 indicates a table recognition result with respect to an input image. First, the item names and item values of the table recognition result are displayed. A user confirms the table recognition result, and designates and inputs an item name or an item area to be corrected, using a mouse, a touch pen, a finger, or the like as needed.

1102 indicates a confirmation and correction finish button. Besides, a window for displaying a list of input images that are confirmed and corrected, the function of undoing correction, or the like may be added.

According to the present embodiment configured in this way, the information processing apparatus 100 performs the table recognition on an input image including a joined table area including different table areas joined, performs the character recognition processing on at least the joined table area of the input image, extracts an item name from a character string obtained as a result of the character recognition processing, and recognizes, when detecting, in a column or a row having one item name as a starting point in the joined table area, an item name different from the one item name at a position advanced in one direction, an area that extends from the different item name as a different table area.

Thus, according to the present embodiment, it is possible to semantically decompose a plurality of different tables joined, to thereby recognize the tables.

Note that, the above-mentioned embodiment, in which the details of the configuration are described for the purpose of easy understanding of the present invention, is not necessarily limited to the one including all the described components. Further, each component of the embodiment can be partly added to, removed from, or replaced by another component.

As an example, in the above-mentioned embodiment, a table area recognized by the table separation and item name-item value association program 113 may be recognized again by the table separation and item name-item value association program 113 in a recursive manner.

Further, item names that are added to the item name dictionary data 123 by the table recognition result correction program 114 may be alternative spelling or expressions of item names already registered in the item name dictionary data 123.

Further, each configuration, function, processing unit, processing means, or the like described above may be partly or entirely achieved by hardware, and for example, an integrated circuit is designed therefor. Further, the present invention can also be achieved by program codes of software that achieves the functions of the embodiment. In this case, a storage medium having the program codes recorded therein is provided to a computer, and the processor of the computer reads the program codes stored in the storage medium. In this case, the program codes read from the storage medium achieve the functions of the above-mentioned embodiment themselves, and the program codes themselves and the storage medium storing the program codes constitute the present invention. Examples of such a storage medium for supplying program codes include flexible disks, CD-ROMs, DVD-ROMs, hard disks, SSDs (Solid State Drives), optical discs, magneto-optical discs, CD-Rs, magnetic tapes, non-volatile memory cards, and ROMs.

Further, the program codes that achieve the functions described in the present embodiment can be implemented by a wide range of programming or scripting languages such as Assembler, C/C++, Perl, Shell, PHP, or Java (registered trademark).

Moreover, the program codes of the software that achieves the functions of the embodiment may be stored in storage means such as a hard disk or a memory of the computer or in a storage medium such as a CD-RW or a CD-R by distributing the program codes via a network, and the processor of the computer may read and execute the program codes stored in the storage means or in the storage medium.

In the above-mentioned embodiment, only control lines and information lines considered to be necessary for the description are described, and not all the control lines and information lines of a product are necessarily described. All the configurations may be coupled to each other.

1. An information processing apparatus which performs table recognition on an input image including a joined table area including different table areas joined, the information processing apparatus configured to:
perform character recognition processing on at least the joined table area of the input image;
extract an item name from a character string obtained as a result of the character recognition processing; and
recognize, when detecting, in a column or a row having one item name as a starting point in the joined table area, an item name different from the one item name at a position advanced in one direction, an area that extends from the different item name as a different table area.

2. The information processing apparatus according to claim 1, wherein the one direction comprises a top-to-bottom direction of the joined table area in the column, and a left-to-right direction of the joined table area in the row.

3. The information processing apparatus according to claim 1, further comprising an item name dictionary,
wherein the information processing apparatus is configured to check the character string obtained as a result of the character recognition processing against the item name dictionary, to thereby extract the item name.

4. The information processing apparatus according to claim 1, wherein the information processing apparatus is configured to extract, as the item name, a character string in a leftmost and uppermost portion of the joined table area.

5. The information processing apparatus according to claim 1, wherein the information processing apparatus is configured to extract, when a plurality of the item names have been extracted in every other row in a direction of the row or in every other column in a direction of the column in the joined table area, the character string sandwiched by the item names as the item name.

6. The information processing apparatus according to claim 1, wherein the information processing apparatus is configured to recognize, when failing to detect, in a column or a row having one item name as a starting point in the joined table area, an item name different from the one item name at a position advanced in one direction, that the column or the row is in the same table area.

7. The information processing apparatus according to claim 1, wherein the information processing apparatus is configured to detect a thickness change and/or a color change of a ruled line in the joined table area, and recognize, as the different table area, an area that extends from the change of the ruled line in a direction of the row or in a direction of the column.

8. The information processing apparatus according to claim 1, wherein the information processing apparatus is configured to detect at least one of a character class change of a font, a thickness change of the font, or a color change in the joined table area, and recognize, as the different table area, an area that extends from the change of the font in a direction of the row or in a direction of the column.

9. The information processing apparatus according to claim 1, wherein the information processing apparatus is configured to recursively recognize the different table area in the table area recognized as the different table area.

10. The information processing apparatus according to claim 1,
wherein the information processing apparatus is configured to record results of recognition indicating the different table area in a database as different tables, and
wherein the different tables each have a link between the different tables.

11. The information processing apparatus according to claim 1, further comprising:
a display apparatus configured to display a recognition result of the table area; and
an input apparatus configured to receive a correction input of a correspondence between the item name and an item value with respect to the recognition result displayed on the display apparatus.

12. The information processing apparatus according to claim 11, further comprising an item name dictionary,
wherein the information processing apparatus is configured to store, in the item name dictionary, the item name newly designated through the input apparatus.

13. The information processing apparatus according to claim 12, wherein the newly designated item name includes an alternative spelling or expression of the item name already included in the item name dictionary.

14. A table recognition method that is performed by an information processing apparatus configured to perform table recognition on an input image including a joined table area including different table areas joined,
the table recognition method, comprising:
performing character recognition processing on at least the joined table area of the input image;
extracting an item name from a character string obtained as a result of the character recognition processing; and
recognizing, when detecting, in a column or a row having one item name as a starting point in the joined table area, an item name different from the one item name at a position advanced in one direction, an area that extends from the different item name as a different table area.
